(19) United States
(12) Patent Application Publication
(10) Pub. No.: US 2026/0091946 A1
(43) Pub. Date: Apr. 2, 2026

(54) VEHICLE BODY

(71) Applicant: MMD Group Limited, Laxey, Isle of Man (GB)

(72) Inventors: Christopher Pearson, Laxey, Isle of Man (GB); Michael Kempton, Laxey, Isle of Man (GB)

(73) Assignee: MMD Group Limited, Laxey, Isle of Man (GB)

(21) Appl. No.: 19/115,600

(22) PCT Filed: Oct. 4, 2023
(86) PCT No.: PCT/GB2023/052558

§ 371 Date: Mar. 26, 2025

(30) Foreign Application Priority Data
Oct. 6, 2022 (GB) 2214711.0

(51) Int. Cl. B65G 67/24; B07B 1/00; B62D 21/02; B62D 29/00

(52) U.S. Cl. CPC B65G 67/24; B07B 1/005; B62D 21/02; B62D 29/00

(57) ABSTRACT

A body for a material conveying vehicle is described. The body has an inner base configured to engage directly upon a chassis of a material conveying vehicle; inner side walls extending upwardly from the inner base to define with the inner base an inner volume for material to be conveyed; an outer base and outer sidewalls comprising continuous sheet material disposed around the inner base and inner side walls. The inner base comprises a rigid apertured network structure having a raised profile that projects away from the outer base, and the inner side walls comprise apertured network structures spaced from the outer sidewalls, thereby defining an intermediate volume into which material smaller than the apertures in the said network structures may pass in use; and the intermediate volume is provided with an outlet system from which material therein may be removed.

### FIELD OF THE INVENTION

This invention relates to a body or hopper for a material conveying truck or like material conveying vehicle. The invention further relates to a vehicle including such a body. The invention for example relates to a material conveying vehicle for the movement of mineral that is a product of a mining or quarrying operation, for example at, about or between a working site and/or a processing site. The invention for example relates to a material conveying vehicle for the movement of hard rock mined ores and the like, mined coal etc.

### BACKGROUND TO THE INVENTION

In mineral operations such as the mining of hard rock ores and the open-cast mining of coal, significant volumes of material need to be handled at and removed from the working site, for example to be moved to a processing site. Typically, a volume of material, known as overburden, has to be removed and disposed of before access is gained to the minerals of interest. Then, the minerals of interest need to removed and transported.

A common mode of transport of material produced by such operation is by use of using trucks. This term is used herein to encompass any discrete transportation module capable of being moved under its own power and comprising a chassis carrying a suitable drive means to drive a suitable ground engaging driven means such as wheels and/or tracks, and supporting a hopper like body into which material may be loaded for transportation.

The use of truck loading to transport material gives a flexible alternative at various stages of the operation both at the primary working site and elsewhere. For example at the primary working site the body of the truck may be loaded with dug mineral, for example using a shovel loader, and the truck may then be used to transport the dug mineral to a large scale mineral processing plant for example located elsewhere in the mine.

A typical truck has a hopper style body defining a volume for mineral or like material can be loaded. A typical body may comprise steel plates of appropriate strength and thickness comprising a bottom or base and upwardly (usually either vertically or outwardly) extending side walls, which term includes longitudinal sides and end walls in the case of a typical rectangular base body. The hopper body, particularly the bottom or base, requires high strength in particular to absorb impact loads as the material is loaded into it. A typical body accordingly tends to be fabricated from solid and thick sheet steel. Alternative designs, additionally incorporating polymers into the structure to modify impact and wear characteristics of the bottom plate in particular are also known, for example as described in EP1473189A2. Such truck body structures are necessarily heavy.

The total vehicle mass of a loaded truck with a load of mineral or like material is large and its movement from place to place to transport the mineral load is energy-intensive.

It is generally desirable to maximize the proportion of target mineral mass to the total loaded truck mass. In particular it is therefore desirable to develop truck hopper body structures that are of reduced weight. Reduced weight solutions will increase the overall efficiency of a truck transport system, not merely by simply reducing the weight of an individual body plus load combination, but with potential compounding advantages if the reduced weight solution facilitates introduction of alternative and more efficient drive trains, sources of motive power (such as battery power) and the like.

It is generally also desirable to seek to restrict the mineral load so far as possible to target mineral only and to avoid transporting material that is likely to be waste. In particular it may be desirable to separate mined mineral by size before transportation to remove fines. Various solutions to the latter requirement are known including the use of rotating trommel mill cylinders, vibrating flat screens and grizzlies.

The invention is directed at the provision of a hopper style body defining a volume for mineral or like material that can be loaded and confers advantages with respect of some or all of the above operational requirements, and of a truck including such a body.

### SUMMARY OF THE INVENTION

In accordance with the invention in a first aspect, a body for a material conveying vehicle comprises:
an inner base configured to engage directly upon a chassis of a material conveying vehicle;
inner side walls extending upwardly from the inner base to define with the inner base a hopper body volume for material to be conveyed;
an outer base and outer sidewalls comprising continuous sheet material disposed around the inner base and inner side walls to define an outer enclosed volume;
wherein the inner base comprises a rigid apertured network structure having a raised profile that projects away from and above the outer base, and the inner side walls comprise apertured network structures spaced from the outer sidewalls, thereby defining an intermediate volume into which material smaller than the apertures in the said network structures may pass in use;
wherein the intermediate volume is provided with an outlet system from which material therein may be removed.

The body thus defines a volume into which material may be loaded and from which material may be unloaded in the usual manner to facilitate transportation in a truck-based transportation system and method. Primarily, material is loaded into the hopper body volume defined by the inner base and side walls.

The invention is distinctly characterized by particular features relating to the inner base and side walls and by the provision of an outer shell, which together confer advantages.

First, an inner base is specifically provided as a rigid loading structure adapted to carry the shock loads that are experienced during loading and directly engaged in use to a vehicle chassis to transmit those shock loads. The inner base may be structured and materials for its construction selected accordingly, which may allow for a reduction in structural strength in the inner side walls and a consequent optimization of the weight of the inner hopper system.

Second, both the inner base and the inner side walls are apertured network structures. Not only does such a structure confer further flexibility in structure and material selection, again offering potential for weight reduction, but by provision of appropriately sized apertures it is possible in a system of the invention to give a capability, as material smaller than the apertures in the said net structure may pass through the apertures in use from the inner hopper volume, for example as the vehicle is moved, to separate fines from material of a more desired target size.

This effect is exploited by the provision of an outer shell which works in conjunction with the inner structures. Together these define between them an intermediate volume into which material smaller than the apertures in the said net structure may pass in use, to separate fines out of the inner hopper volume and into the intermediate volume. The fines may then be removed from the intermediate volume via a suitable outlet system, and thus the inefficiency of transporting the fines with the target load may be reduced.

As the outer shell does not directly contain the primary load, it does not require the structural strength of a conventional single body shell. The novel combined structure may thus combine a potential for weight saving in the body itself with a potential to segregate and discard fines to give a potential for weight saving in the load, the two effects combining to contribute to the objective of reducing overall weight while maximizing proportion of target mineral weight to the total loaded truck weight, with the efficiency and other advantages discussed above that might accrue.

It is a characteristic feature of the invention that the inner base and the inner sidewalls making up the inner body and defining the hopper volume comprise network structures. This term is used here in in the broadest topological sense, wherein a network comprises a continuous matrix extending in two dimensions to define plural arrayed apertures within it. No particular structure, shape or configuration for that continuous matrix or array should be considered to be implicit in the term. In particular, a network structure in accordance with the principles of the invention may extend to interlocking arrays of plural elongate rigid or flexible members, such as woven, fused, mechanically engaged structures or the like, as well as structures with apertures formed in or fabricated with a monolithic matrix, and combinations of the same.

At least a major part of the inner base and at least a major part of each inner sidewall is so apertured, conferring advantages in terms of the possibility of weight saving design options, and secondary advantages in terms of the passage of fines through and out of the inner volume as discussed above.

At least the inner base compromises a rigid structure in the sense that it is functionally rigid under the loading conditions expected in use. The base is thus designed to carry the major part of the load of the material to be transported, and in particular to carry shock loads as the material is loaded into the volume.

Various alternative rigid apertured network structures that might perform a function of separation by size will be familiar to the person skilled in the mineral processing art including rotating trommel mill cylinders, vibrating flat screens and grizzlies.

Generally, the rigid apertured network structure of the inner base may draw on such design principles as are commonly within the compass of the skilled person and comprise a two dimensional skeleton of rigid elongate bars, rods or the like forming a rigid network that defines apertures between them of a desired size to allow finer material to pass through. The rigid elongate bars, rods or the like forming the rigid network may be metal and for example steel. They may be welded or mechanically engaged to each other. Other materials for example surrounding or coating the bars, rods or the like forming the rigid network may be provided in conjunction therewith to give further desired properties.

The structure and conformation of the inner base network structure may advantageously draw on principles known in the art from trommel screen technology. A trommel screen is known in the mineral processing art as a rotary drum screen that is used to separate materials, having a network structure forming a cylindrical drum that that may be elevated towards a feed end and pass down towards a discharge end so that as material passes down the rotating drum undersized material is screened out and passes through the screen.

In essence the same principles may be applied if the inner base plate of the invention comprises a similar structure. Movement of materials sitting towards the bottom of the hopper volume on the inner base plate, for example as the vehicle is moved to transport the material, will tend to cause finer material to pass through the apertures into the intermediate volume for subsequent discharge.

Accordingly, in preferred embodiments, the inner base comprises one or more suitably shaped and for example flat or arcuate trommel screen plates.

The inner sidewalls may conveniently comprise flexible network structures, and may for example comprise flexible wire mesh structures, for example comprising interlinked wire mesh structures such as woven, knitted or bonded wire meshes, with the apertured portions comprising the gaps formed by the mesh.

Such flexible network structures may optionally be partly reinforced with a secondary network of rigid elongate members to give an increased degree of structural form and/or strength and/or rigidity to the inner side wall.

As will be generally understood, references to rigid or flexible properties of materials, components or structures are references to be interpreted in the context of whether the material, component or structure is functionally rigid or flexible under the loading conditions expected in use, and where applicable under the shock-loading conditions experienced as material is loaded into the body for use.

The inner base is shaped to present a generally raised profile that projects generally above the outer base to define a space that comprises a part of the intermediate volume between them. In this sense, the shape of the base is outwardly generally convex.

In a particular preferred case, the base may define a continuous outward profile in a longitudinal direction and define a generally convex outward profile transversely to that longitudinal direction.

In one example of such an arrangement, the inner base may be an arcuate portion of a cylinder, and for example may comprise an arcuate portion of a trommel drum structure. In an alternative example of such an arrangement, plural flat plates, which are, for example trammel screen plates, are arranged in a polygonal arcuate form.

In a most preferable case, a pair of such plates is provided having a V-shaped outward profile. The projecting edge thereby created is found to be particularly effective in absorbing shock loads as the material is loaded into the inner volume, and may even be designed to provide a functionality in breaking up larger lumps of mineral.

The outer shell of the body, comprising the outer face and outer sidewalls, does not require the same structural strength as a conventional single body. Nevertheless, it is generally preferable that the outer base and outer walls comprise continuous and rigid sheet structures. Suitable material for the sheet structures might include metal plates and for example steel plate. Nevertheless, the material may be much thinner than a conventional single body panel, given the lesser loading requirements.

All of the above structural and material selections give possibility of lighter weight to the combined twin layer body for the material conveying vehicle in accordance with the invention.

The inner structure and outer shell are spaced apart so as to define between them and intermediate volume into which material smaller than the apertures in the network structures making up the inner bay and the inner sidewalls may pass n use, for example as the load vibrates as the vehicle moves.

Outlet apertures in the outer shell, for example in the base or in the sides towards the base, may provide an outlet system from which the finer material passing into the intermediate volume may then be discarded. These outlet apertures may include selectively operable closures. Conveniently, these outlet apertures may be disposed such that the discarding function is effective in use under the action of gravity, for example in that segregated material is simply discarded as the truck moves. Alternative methods of removal may be appropriate if such a direct discard is not acceptable. In either case, the discard of the material such as the mineral fines that have been segregated into the intermediate volume avoids their unnecessary transportation.

The structure in use may thus advantageously combine a potential for weight saving in the body itself with a potential to maximize the proportion of target mineral weight within the load to the total loaded truck weight by segregating and discarding of fines.

In a further more complete aspect of the invention, a material conveying vehicle comprises a body in accordance with the first aspect mounted upon a vehicle base.

In particular, the vehicle base comprises:
a chassis, with the body mounted upon the chassis such as to be supported thereupon, and in particular such that the inner base engages and is supported directly thereupon;
a ground engaging transport system mounted on the chassis to enable the vehicle to move across the ground in use, for example comprising wheels, rollers, tracks or combinations thereof;
a drive system to provide driving power to the transport system, for example including an engine and transmission system, wherein the engine may for example be an internal combustion engine, an electrical engine or the like;
a power source for the engine, for example comprising a supply of internal combustion fuel, a battery or the like.

Thus, in accordance with the invention in the second aspect, a material conveying vehicle comprises:
a body in accordance with the first aspect of the invention;
a chassis, wherein the body is mounted upon the chassis such as to be supported thereupon, and in particular such that the inner base engages and is supported directly thereupon;
a ground engaging transport system mounted on the chassis to enable the vehicle to move across the ground in use, for example comprising wheels, rollers, tracks or combinations thereof;
a drive system to provide driving power to the transport system, for example including an engine and transmission system, wherein the engine may for example be an internal combustion engine, an electrical engine or the like;
a power source for the engine, for example comprising a supply of internal combustion fuel, a battery or the like.

The advantages offered by the novel body of the first aspect of the invention, in relation to reduced weight while keeping adaptation to the high impact loads associated with mineral transportation, and combining this with a fines separation function, produces a vehicle that is admirably suited to the efficient and effective transport of mineral that is a product of a mining or quarrying operation, for example at, about or between a working site and/or a processing site.

### BRIEF DESCRIPTION OF THE DRAWINGS

The invention will now be described by way of example only, with reference to FIGS. 1 to 4 of the accompany drawings, which illustrate an exemplary embodiment of the invention, in which:

FIG. 1 shows in simple schematic a perspective view from above of a vehicle including a body in accordance with an embodiment of the invention;

FIG. 2 is a partial cutaway of the view of FIG. 1;

FIG. 3 is a side elevation of the vehicle of FIG. 1;

FIG. 4 is an end elevation of the vehicle in FIG. 1.

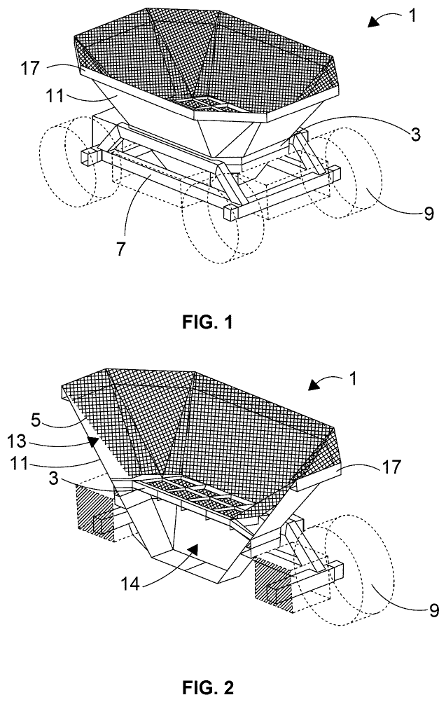

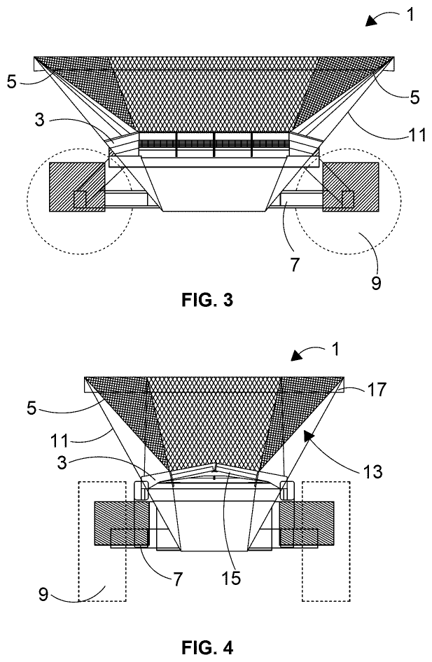

### DETAILED DESCRIPTION OF THE ILLUSTRATED EMBODIMENTS

An embodiment of a vehicle according to the second aspect of the invention including a body according to the first aspect of the invention is shown by way of example in the figures.

The vehicle is shown in simple schematic, respectively as a perspective view from above, as a partially cutaway perspective view from above, and in side and end elevation.

The vehicle body comprises in general terms a hopper 1 which defines a volume for the carriage of material to be transported, having a base 3 and upwardly and outwardly extending sidewalls 5 in familiar manner.

In familiar manner, the body is carried and supported on a chassis 7, which is provided with four wheels 9 to enable the vehicle to move across the ground in use. The wheels 9 are mounted in pairs on respective axles to the chassis, and provided with suitable drive means to cause at least one driven axle to rotate under action of a suitable powertrain to cause the vehicle to be driven along the ground in use.

The vehicle is distinctly characterised by the particular two part structure of the body, which comprises a base 3 and side walls 5 defining an inner mineral containing volume, contained within an outer shell 11, defining an intermediate volume 13, 14 between the shell and the inner volume.

In the illustrated embodiment, the shell 11 comprises multiple steel plates in generally familiar manner, but because to load is carried and contained within the inner volume, and the consequent different functionality performed by the outer shell compared with that of a single body shell of conventional design, these plates require less mechanical strength and can be thinner and lighter.

The inner mineral containing volume is defined by a base formation 3 comprising a pair of planar apertured formations based on a trommel screen principle. These trommel screen formations extend in a longitudinal direction and are positioned relative to each other to project upwardly towards a central longitudinally extending line of contact to produce a V-shaped profile 15 to the structure.

The purpose of this base formation 3 is to provide most of the strength to deal with the mineral load in the hopper volume, and in particular the initial shock loading as heavy mineral material is dropped into the hopper volume. The V-shaped profile 15 and projecting edge in particular are admirably suited to this role.

The inner hopper volume is further defined by flexible wire netting sides 5 that extend from respective upper edges 17 of the plates the make up the outer shell 11 to the base formation 3. The wire netting panels 5 in the illustrate embodiment are rhombic wire nets.

This arrangement has the effect of spacing the netting sides 5 away from the inside surfaces of the plates of the outer shell, creating a space 13 that together with the space 15 below the V-shaped base formation and the flat base plate of the outer shell forms an intermediate volume through which material which is sufficiently small to pass through either the apertures in the bottom formation 3 or the apertures in the nets that form the sides 5 can pass during use.

This arrangement enables segregation between larger lumps of target mineral that are thereby retained within the inner volume and fines of a size less than the mesh sizes of the sides 5 and the base formation 3 which pass through and into the intermediate volume 13, 14. Advantageously, agitation of the load by movement of the vehicle may be used to cause this segregation.

The segregated fines may be discarded by suitable discharge ports. Further advantageously, movement of the vehicle may be used to encourage this discharge under action of gravity.

The particular combination of structural elements of the body of the vehicle in the illustrated embodiment offers a novel and advantageous combination of high impact performance through the rigid v-shaped inner base formation, a light body through the combination of the mesh structure and the thin steel outer shell, and a size separation function via the apertures in the inner base formation and the nesh of the side nets. These functions work together to produce a better target mineral load/overall weight ratio and more efficient loading system for the transport of mineral materials, in particular at, about and from a working site such as mining or quarrying site.

A suitable method of operation to transport mineral material for example from a mining or quarrying operation might comprise in a third aspect of the invention:
providing a vehicle in accordance with the second aspect of the invention;
loading material into an inner volume thereof;
causing material to pass into the intermediate volume by agitating the loaded material, for example by moving the vehicle;
optionally, discarding the material passed into the intermediate volume;
moving the vehicle to transport the material in the inner volume.

1. A body for a material conveying vehicle comprising:
an inner base configured to engage directly upon a chassis of a material conveying vehicle;
inner side walls extending upwardly from the inner base to define with the inner base an inner volume for material to be conveyed;
an outer base and outer sidewalls comprising continuous sheet material disposed around the inner base and inner side walls;
wherein the inner base comprises a rigid apertured network structure having a raised profile that projects away from the outer base, and the inner side walls comprise apertured network structures spaced from the outer sidewalls, thereby defining an intermediate volume into which material smaller than the apertures in the said network structures may pass in use;
wherein the intermediate volume is provided with an outlet system from which material therein may be removed.

2. A body in accordance with claim 1 wherein the inner base comprises a two dimensional skeleton of rigid elongate bars or rods forming a rigid network that defines apertures between.

3. A body in accordance with claim 2 wherein the rigid elongate bars or rods comprise steel.

4. A body in accordance with claim 2 wherein the rigid elongate bars or rods are welded or mechanically engaged to each other to form the rigid network.

5. A body in accordance with claim 1 wherein the two dimensional skeleton further comprises other materials surrounding or coating the bars or rods.

6. A body in accordance with claim 1 wherein the inner base comprises a trommel screen.

7. A body in accordance with claim 6 wherein the inner base comprises one or more flat or arcuate trommel screen plates.

8. A body in accordance with claim 1 wherein the inner sidewalls comprise flexible network structures.

9. A body in accordance with claim 8 wherein the inner sidewalls comprise flexible wire mesh structures, optionally partly reinforced with a secondary network of rigid elongate members.

10. A body in accordance with claim 1 wherein the the inner base comprises an upwardly projecting arcuate portion of a cylinder.

11. A body in accordance with claim 1 wherein the inner base comprises a pair of plates configured to define an upwardly projecting V-shaped outward profile.

12. A body in accordance with claim 1 wherein outlet apertures in the outer shell are provided from which the finer material passing into the intermediate volume may be discarded from the intermediate volume in use.

13. A material conveying vehicle comprising a body mounted upon a vehicle base, wherein the body comprises:
an inner base configured to engage directly upon a chassis of a material conveying vehicle;
inner side walls extending upwardly from the inner base to define with the inner base an inner volume for material to be conveyed;
an outer base and outer sidewalls comprising continuous sheet material disposed around the inner base and inner side walls;
wherein the inner base comprises a rigid apertured network structure having a raised profile that projects away from the outer base, and the inner side walls comprise apertured network structures spaced from the outer sidewalls, thereby defining an intermediate volume into which material smaller than the apertures in the said network structures may pass in use;
wherein the intermediate volume is provided with an outlet system from which material therein may be removed.

14. The material conveying vehicle in accordance with claim 13, wherein the vehicle base comprises:
a chassis, wherein the body is mounted upon the chassis, and wherein the inner base engages and is supported by the chassis;
a ground engaging transport system mounted on the chassis to enable the vehicle to move across the ground in use;
a drive system to provide driving power to the transport system, wherein the drive system comprises an engine and transmission system;
a power source for the engine.

15. A method of transportation of mineral material comprising:
providing a vehicle in accordance with claim 13;
loading material into an inner volume thereof;
causing material to pass into the intermediate volume by agitating the loaded material;
optionally, discarding the material passed into the intermediate volume; and
moving the vehicle to transport the material in the inner volume.

16. The material conveying vehicle in accordance with claim 14, wherein the ground engaging transport system comprises wheels, rollers, tracks or combinations thereof.

17. The material conveying vehicle in accordance with claim 14, wherein the engine is an internal combustion engine or an electrical engine.

18. The material conveying vehicle in accordance with claim 14, wherein the power source comprises a supply of internal combustion fuel or a battery.
